(19) United States
(12) Patent Application Publication
(10) Pub. No.: US 2026/0099677 A1
(43) Pub. Date: Apr. 9, 2026

(54) DYNAMIC PROMPT TEMPLATE ENFORCEMENT AND CATEGORIZATION SYSTEM

(71) Applicant: American Express Travel Related Services Company, Inc., New York, NY (US)

(72) Inventors: Alaric M. Eby, New York, NY (US); Andras L. Ferenczi, Scottsdale, AZ (US); Hilary Packer, Scottsdale, AZ (US)

(21) Appl. No.: 18/910,610

(22) Filed: Oct. 9, 2024

(51) Int. Cl. G06F 40/35

(52) U.S. Cl. CPC G06F 40/35

(57) ABSTRACT

Disclosed are various embodiments for dynamic enforcement of large language model prompt templates and prompt template categorization. In one example, a system comprise a computing device that is configured to identify a prompt that has been submitted by a client device for a large language model (LLM) service and determine that the prompt fails to match an existing prompt template. The prompt and an unidentified prompt are determined to meet a similarity threshold based at least in part on a common prompt component shared between the prompt and the unidentified prompt. A prompt template is generated for the LLM service based at least in part on the prompt and the unidentified prompt meeting the similarity threshold, the prompt template comprising the common prompt component and a placeholder.

### BACKGROUND

Prompt templates have emerged as a useful tool for interfacing with generative artificial intelligence systems. A prompt template can represent a predefined, structured large language model prompt that has one or more placeholders for user-specified parameters. As a result, prompt templates serve as a reusable framework for instructing a generative artificial intelligence system to execute a particular task.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of an example scenario of an alert of an improper use of a prompt template according to various embodiments of the present disclosure.

FIG. 2 is a drawing of a network environment according to various embodiments of the present disclosure.

FIG. 3 is a sequence diagram illustrating one example of functionality executed in the network environment of FIG. 2 according to various embodiments of the present disclosure.

FIG. 4 is a flowchart illustrating one example of functionality implemented as portions of a management service executed in a computing environment in the network environment of FIG. 2 according to various embodiments of the present disclosure.

FIG. 5 is a flowchart illustrating one example of functionality implemented as portions of an agent service executed in a computing environment in the network environment of FIG. 2 according to various embodiments of the present disclosure.

### DETAILED DESCRIPTION

Disclosed are various approaches for dynamic enforcement of large language model (LLM) prompt templates and prompt template categorization of incoming prompts. A prompt template can represent a predefined, structured large language model prompt with one or more placeholders for user-specified parameters. Prompt templates can provide a useful starting point for generating a prompt because they include relevant prompt components for requesting a large language model to execute a particular task.

However, prompt templates can be used inappropriately and can be a cybersecurity concern for an organization. For example, regulations, guidelines, and laws continue to evolve around the appropriate use of artificial intelligence and machine learning technologies in order to protect the public. As a result, businesses may need to monitor the use of large language models and their prompt templates in order to ensure compliance.

In some instances, organizations have an approval process for prompt templates before they can be used by employees. However, businesses cannot track whether the actual prompts generated from the approved prompt templates are in compliance with the approved prompt template. For example, an approved prompt template can be selected and used as an initial starting point of a prompt. However, the user can continue to add instructions to the prompt that go beyond the authorized used of the prompt template.

In other cases, malicious users can generate prompt injection attacks. A prompt injection attack is a type of cyberattack used to manipulate large language models for malicious purposes. The malicious users can disguise malicious inputs as legitimate prompts in order to manipulate the LLM service into leaking sensitive data or spreading misinformation. For example, the malicious users can instruct the LLM service to ignore security policies and instruct the LLM service to transmit sensitive information.

Accordingly, various embodiments of the present disclosure can improve the performance and security of prompt templates used by large language model services. For example, the various embodiments can provide a mechanism for automating the generation of new prompt templates based at least in part on an analysis of previous submitted prompt templates. In some instances, an administrative user can be notified of new prompt templates and administrative user approval can be required before the new prompt templates are available to users.

Further, the various embodiments of the present disclosure can monitor for appropriate use of prompts and prompt templates. The various embodiments can track metrics related to prompts and/or prompt templates in order to detect suspicious conditions (e.g., anomalies and/or suspicious activity, such as denial of service attacks). These conditions can generate an alert for an investigation by an administrative user.

In addition, the various embodiments can classify incoming prompts in one or more template categories for tracking prompt metrics. However, if incoming prompts cannot be classified into a template category, then the incoming prompts can be analyzed for prompt injection characteristics or other suitable malicious security characteristics. As such, the various embodiments provide advantages relating to dynamically being able to categorize incoming LLM prompts into prompt templates, adaptively manage new and evolving prompt templates in a systematic approach.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

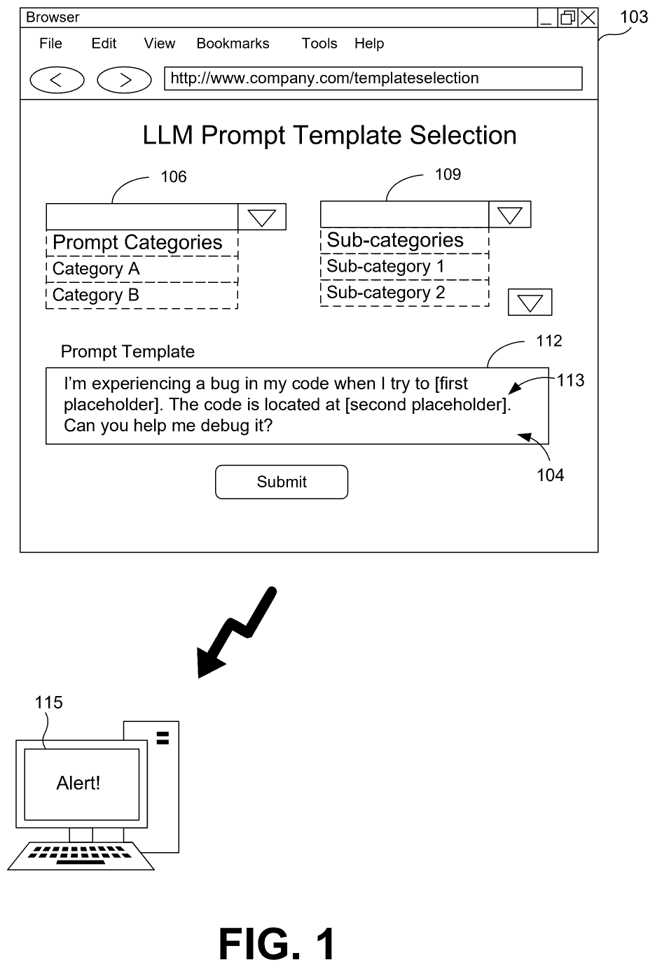

As illustrated in FIG. 1, shown is an example user interface 103 that allows for a user to select a prompt template 104 for a LLM service. The user interface 103 includes a prompt category component 106, a sub-category component 109, a prompt template field 112, and other suitable components. The prompt category component 106 can be configured to allow the user to select a prompt category. Based on the prompt category, the sub-category component 109 can include a list of sub-categories associated with the selected prompt category. The prompt category and the sub-category can allow for a user to filter various prompt templates in order to identify a particular prompt template for executing a desired task.

After the prompt category and the sub-category have been selected, the prompt template field 112 can populate with a prompt template 104. The prompt template 104 can include a predefined structure of text and one or more placeholders 113 related to executing the desired task. The placeholders 113 can represent a location in the prompt template 104 for the user to enter data, such as a parameter, a variable, or other suitable data. After data has been entered at the placeholders 113 by way of the prompt template field 112, the user can submit the prompt template 104 to the LLM service.

Also, FIG. 1 shows an administrative user interface 115 for displaying prompt template metrics and alerts. For example, the administrative user interface 115 can display metrics relating to a number of times the prompt template 104 has been submitted, placeholder metrics data, metrics relating to how the prompt template 104 is deployed, average latency, distributions of requests over time period, and other suitable prompt metrics.

As shown in the example depicted in FIG. 1, the administrative user interface 115 can generate alerts relating to the prompt metrics. For example, a prompt template 104 can be approved within a business for fifty (50) users and prompt metric thresholds can be configured for these the approved users. For instance, a maximum threshold of two-hundred (200) prompt requests/month and a minimum threshold of twenty (20) prompt requests/month can be set for these fifty (50) users. If the actual number of prompt requests for the month is beyond the maximum threshold, then an alert can be generated because suspicious activity may be the cause of the excessive prompt requests (e.g., a denial of service attack). In some instances, if a threshold is reached, the prompt template 104 can be suspended in order to prevent further submission of the prompt template 104 to the LLM application. In this instance, the prompt template 104 can be disable (e.g., removed as a selectable prompt template 104) from use in the user interface 103.

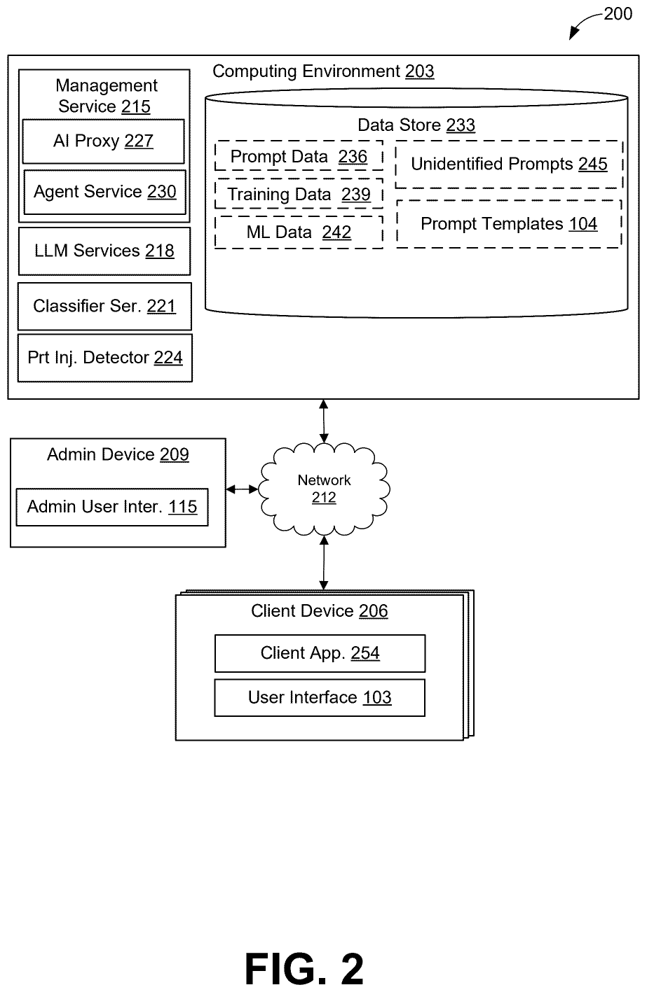

With reference to FIG. 2, shown is a network environment 200 according to various embodiments. The network environment 200 can include a computing environment 203, a client device 206, and an administrative device 209, which can be in data communication with each other via a network 212.

The network 212 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 212 can also include a combination of two or more networks 212. Examples of networks 212 can include the Internet, intranets, extranets, virtual private networks (VPNs), and similar networks.

The computing environment 203 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 203 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 203. The components executed on the computing environment 203 include a management service 215, a LLM service 218, a classifier service 221, a prompt injection detector 224, and other applications, services, processes, systems, engines, or functionality not discussed in detail herein.

The management service 215 can be executed to manage or coordinate various tasks related to tracking the use of prompt templates 104. The management service 215 can use the LLM service 218 to assist with the execution of various tasks related to prompt templates 104. In some embodiments, the management service 215 can include an artificial intelligence (AI) proxy 227 and an agent service 230. In some examples, functionality can be segmented in this manner in order to implement an artificial intelligence architecture that uses an agent to manage and coordinate a series of tasks to be performed by LLM service 218 as part of an autonomous execution of a workflow of tasks.

The AI proxy 227 can be executed to monitor application payloads, relay data to the agent service 230, interface with the LLM service 218, and other suitable functionality. In some examples, the AI proxy 227 can be omitted and the management service 215 can execute the functionality assigned by the AI proxy 227.

The agent service 230 can be executed to coordinate an autonomous execution of a workflow. Some examples of tasks performed in the workflow can include the classification of incoming prompts into template categories (e.g., prompt templates 104), the generation of new prompt templates 104 from incoming prompts, facilitating the analysis of incoming prompts for malicious activity, and other functionality. The agent service 230 can interface with the LLM service 218, the classifier service 221, the prompt injection detector 224, and other suitable services.

The LLM service 218 can represent a large language model that is executed for natural language processing tasks. In some examples, the LLM service 218 can include a large language model that utilizes a transformer model that includes feed forward layers, embedding layers, encoding layers, attention layers, and/or other suitable components. In some examples, the LLM service 218 can include a large language model that utilizes other architectural approaches (e.g., recurrent neural networks, long short-term memory networks, etc.). The LLM service 218 can use a large language model prompt for generating a general-purpose language response. The large language model prompt can represent one or more statements (e.g., a series of text characters) or an image that provides one or more instructions for the LLM service 218 to execute.

The LLM service 218 can be executed to use a large language model for interpreting natural language instructions, executing the instructions, and providing a natural language response associated with the execution of the instructions. The large learning models used by the LLM service 218 can be trained (e.g., fine-tuning), evaluated, validated, and deployed for analyzing an incoming prompt submitted by a user. For example, the large learning models can be fine-tuned for generating a new prompt template 104 based at least in part on receiving similar incoming prompts over a period of time. In some examples, the LLM service 218 can include a dedicated template identifier LLM for this task, in which the template identifier LLM can be a separate template identifier LLM service.

In another example, the LLM service 218 can include a dedicated sample generator LLM service that is fine-tuned for generating training data for the new prompt template 104, in which the sample generator LLM is a separate sample generator LLM service. In some examples, the sample generator LLM can be used for generating new training data (e.g., samples) for training a classifier service (e.g., classifier machine learning model) to classify incoming prompts for the new prompt template category.

The classifier service 221 can be executed to classify an incoming prompt with one of the known prompt templates 104 (e.g., prompt category). If the incoming prompt does not match or is not similar enough to match one of the known prompt template 104, then the classifier service 221 can return that the incoming prompt as an unknown. Otherwise, the classifier service 221 can indicate that the incoming prompt is known or can specify that a particular prompt template 104 has been selected for the incoming prompt.

In some examples, the classifier service 221 can be updated after a new prompt template 104 has been created. The update can involve receiving a classification machine learning model that has been trained to identify incoming prompts that should be classified for the new prompt template 104.

The prompt injection detector 224 can be executed to determine whether an LLM prompt is associated with a prompt injection attack. In some examples, the prompt injection detector 224 can receive incoming prompts that are not classified with the existing prompt template 104. Since the incoming LLM prompt is unknown, it can be analyzed for malicious activity. If malicious activity is detected, then the prompt injection detector 224 can transmit an alert for display on the administrative device 209.

Also, various data can be stored in a data store 233 that is accessible to the computing environment 203. The data store 233 can be representative of a plurality of data stores 233, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 233 is associated with the operation of the various applications or functional entities described below. This data can include prompt data 236, training data 239, machine learning data 242, unidentified prompts 245, prompt templates 104, and potentially other data.

The prompt data 236 can represent data associated with incoming prompts. Some non-limiting examples of the prompt data 236 can include client device data (e.g., an Internet Protocol address, device identifier, etc.) that has submitted an incoming prompt, user identifier data (e.g., user identifier, user security credentials, etc.) associated the incoming prompt, prompt characteristics, and other suitable prompt data. Prompt characteristics can include the prompt text, a software application associated with the prompt, and other suitable prompt data.

The training data 239 can represent data associated with training samples, training datasets, and other suitable training data 239 for training a machine learning model for a particular task. In some examples, the training data 239 is generated by the LLM service 218 (e.g., a sample generator LLM service) after a new prompt template 104 has been created. In some instances, the training data 239 can be generated based at least in part on an LLM prompt that has been classified as being associated with prompt injection attack. In these instance, the training data 239 can be used for retraining the prompt injection detector 224.

The machine learning data 242 can represent data associated with machine learning models used by the computing environment 203. In some examples, each machine learning model can be associated with a particular task. For instance, a classifier neutral network model can be generated and trained to classify incoming prompts as matching a category of a particular prompt template 104. The classifier neutral network model can be employed by the classifier service 221 for classification tasks.

The unidentified prompts 245 can represent data associated with incoming prompts that have not been associated with a category of the prompt templates 104. The unidentified prompts 245 can collect and store these prompts for various tasks. For example, one or more unidentified prompts 245 can be compared with each other to determine whether a new category for a prompt template 104 should be created. In some instances, a new prompt template 104 can be stored as an unidentified prompt 245 until an administrative user (via an administrative device 209) has approved of the new prompt template 104. In other examples, the unidentified prompts 245 can analyzed for malicious activity.

The prompt templates 104 can represent data associated with one or more prompt template categories. In some examples, each prompt template category can represent a template that has been approved or vetted. Some non-limiting examples of developer prompt templates 104 can include a code debug template, a code generation template, a test case generator template, and other suitable developer prompt templates. Some non-limiting examples of marketing prompt templates 104 can include a product announcement template, a product blog template, a marketing report template, and other suitable marketing prompt templates.

In some examples, the prompt templates 104 and/or the unidentified prompts 245 can be implemented as a data structure for storing the various data elements, such as placeholders, text characters, a template identifier, common prompt component characteristics, and other suitable data elements. The data structure can include other analytics from the prompt data 236, the training data 239, the ML data 242, and other suitable data sources.

The client device 206 can be representative of a plurality of client devices that can be coupled to the network 212. The client device 206 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, Blu-ray® players, digital video disc (DVD) players, set-top boxes, and similar devices), a videogame console, or other devices with like capability. The client device 206 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 206 or can be connected to the client device 206 through a wired or wireless connection.

The client device 206 can be configured to execute various applications such as a client application 254 or other applications. The client application 254 can present a software application that interacts with the computing environment 203. The client application 254 can transmit LLM prompts which can be identified by the management service 215 for prompt categorization and further analysis. The client application 254 can be executed in a client device 206 to access network content served up by the computing environment 203 or other servers, thereby rendering a user interface 103 on the display. To this end, the client application 254 can include a browser, a dedicated application, or other executable, and the user interface 103 can include a network page, an application screen, or other user mechanism for obtaining user input. The client device 206 can be configured to execute applications beyond the client application 254 such as email applications, social networking applications, word processors, spreadsheets, or other applications.

The administrative device 209 is representative of a plurality of client devices that can be coupled to the network 212. Similar to the client device 206, the administrative device 209 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, and similar devices), or other devices with like capability.

The administrative device 209 can include one or more displays for an administrative user interface 115. In some examples, the administrative user interface 115 can be accessible for an administrative user that logins with security credentials. The administrative user interface 115 can display data associated with the operations of the computing environment 203. For example, the administrative user interface 115 can display alerts generated for suspicious or malicious activity. Suspicious activity can represent unexpected prompt template usage (e.g., excessive usage, low usage, prompt template drift for LLM responses diverging over time, etc.). Malicious activity can represent malicious attacks, such as a denial of service attack, a prompt injection attack, and other suitable malicious attacks. Additionally, the administrative user interface 115 can display performance metrics for the prompt data 236, training data 239, and other suitable data accessible in the data store 233. The administrative user interface 115 can be used to approve or deny a new prompt template 104.

Next, a general description of the operation of the various components of the network environment 200 is provided. To begin, a computing environment 203 can start with an initial phase of data collection and creation of prompt templates 104. For example, users can use the client application 254 to register a new prompt template 104 with the management service 215. The registration process can include identifying a prompt template 104 with a context path and/or a software application.

In some examples, as incoming prompts are received, the incoming prompts can be stored in the unidentified prompts 245. The management service 215 can request the LLM service 218 to determine whether each new incoming prompt matches in similarity with a previously stored unidentified prompt 245. The LLM service 218 can determine whether the new incoming prompt and one or more previously stored unidentified prompt 245 meet a similarity threshold. The comparison for the similarity threshold can be based at least in part on whether there are common prompt components, such as shared instructions, a shared prompt structure, a shared prompt feature, a shared pattern, a common theme, and other suitable similar elements. When a match is identified by the LLM service 218, the management service 215 can generate a new prompt template 104 based at least in part on the common prompt components.

Upon the creation of the new prompt template 104, the management service 215 can instruct the LLM service 218 to generate training data 239 for the new prompt template 104. The management service 215 can provide the training data 239 to a classifier service 221 in order to train an artificial neural network machine learning model for identifying prompts that match the new prompt template 104. After being trained, the artificial neural network machine learning model can be added to the classifier service 221 for classifying incoming prompts as associated with a prompt template 104.

In some example scenarios, the computing environment 203 can operate in a prompt processing phase. In this phase, multiple prompt templates 104 can be established for classifying or categorizing incoming prompts. For instance, the management service 215 can identify a LLM prompt submitted by the client application 254. The management service 215 can transmit the incoming LLM prompt to a classifier service 221. In some examples, the classifier service 221 can have a classifier associated with each individual prompt template 104. Upon one of the classifiers indicating a match, the classifier service 221 can indicate that the incoming LLM prompt matches the identified prompt template 104. As such, the incoming LLM prompt is categorized or classified for the prompt template 104. The management service 215 can generate prompt data 236 based at least in part on the classification. Over time, the prompt data 236 can be evaluated to determine if there are anomalies or suspicious activity. For instance, if the prompt data 236 indicates that the quantity of requests for a prompt template 104 exceeds a security threshold for the prompt template 104, then the management service 215 can transmit an alert on the administrative device 209. Alternatively, the management service 215 can transmit an alert for low usage or other unexpected usage patterns (e.g., unexpected placeholder data, unexpected prompt instructions, etc.).

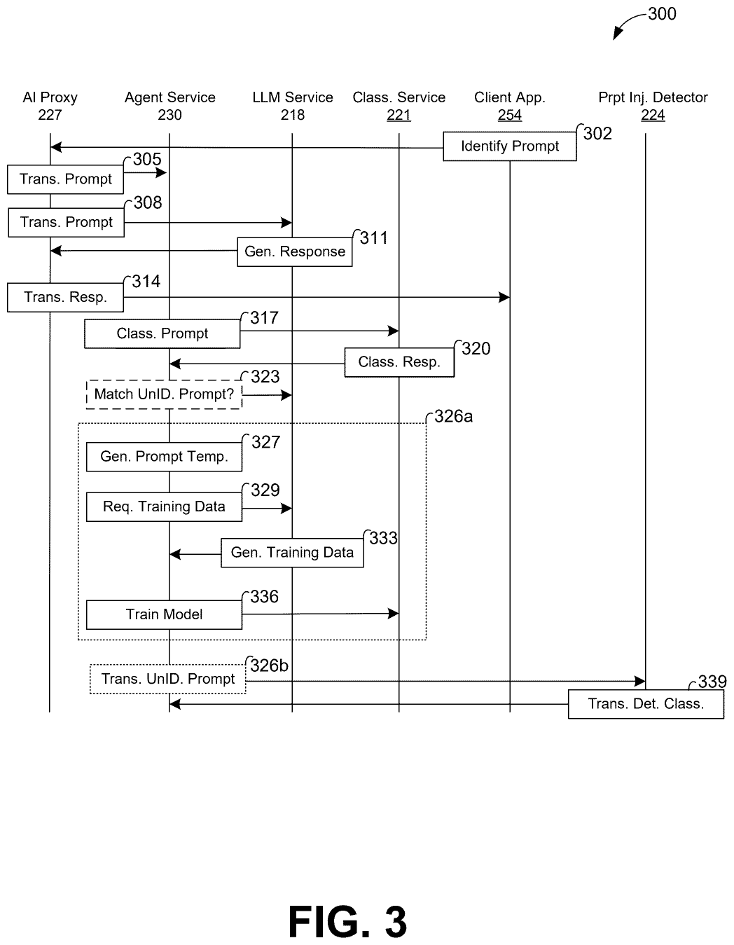

Referring next to FIG. 3, shown is a sequence diagram 300 of example operations of the network environment 200 (FIG. 2). To begin, the depicted sequence diagram 300 is one example for partitioning the functionality of the operations of the network environment 200. Other implementations can vary.

In block 302, the client application 254 can transmit an LLM prompt to the computer environment 203, in which the LLM prompt is intended for the LLM service 218. The LLM prompt can request the execution of a task by the LLM service 218. In this depicted example, the AI proxy 227 can identify the LLM prompt from the client application 254. In some examples, the AI proxy 227 can monitor application payloads from the client application 254 and can identify the LLM prompt from the application payload.

In block 305, the AI proxy 227 can transmit the LLM prompt to the agent service 230 for processing. The agent service 230 can be provided the LLM prompt for an autonomous execution of a workflow. The agent service 230 can be assigned to coordinate the execution of various tasks within the workflow, and the various tasks can involve multiple computing entities. In some examples, the client application 254 can directly transmit the LLM prompt to the agent service 230.

In block 308, the AI proxy 227 can transmit the LLM prompt to the LLM service 218 for a response. In some examples, the client application 254 can directly route the LLM prompt to the LLM service 218 and/or the agent service 230. In some embodiments, the AI proxy 227 and/or the agent service 230 can transmit the LLM prompt to the prompt injection detector 224 for analysis prior to sending the LLM prompt to the LLM service 218. After the prompt injection detector 224 has replied with an approval indicator, then the AI proxy 227 and/or the agent service 230 can transmit the LLM prompt to the LLM service 218. In these embodiments, the LLM prompt can be scanned for malicious activity prior to transmitting the LLM prompt in order to avoid compromising the LLM service 218.

In block 311, the LLM service 218 can receive the LLM prompt from the AI proxy 227 and generate a LLM response. The LLM service 218 can be executed to use a large language model for interpreting natural language instructions, executing the instructions, and providing a natural language response associated with the execution of the instructions. The large learning models used by the LLM service 218 can be trained (e.g., fine-tuning), evaluated, validated, and deployed for analyzing an incoming prompt submitted by a user. In the depicted example, the LLM service 218 can transmit the generated LLM response to the AI proxy 227 for forwarding to the client application 254.

In block 314, the AI proxy 227 can transmit the LLM response to the client application 254 for display on the client device 206. In some examples, the AI proxy 227 can accumulate metrics associated with the LLM prompt and the LLM response for storage as prompt data 236. For instance, the metrics can be used to identify an improper use of a prompt template 104, an effectiveness of the prompt template 104, or other suitable uses. The LLM response can be associated with the prompt template 104. In some examples, the LLM service 218 can transmit the LLM response to the client application 254.

In block 317, the agent service 230 can transmit a request to the classifier service 221 for determining whether the LLM prompt matches one or more of the prompt templates 104. The classifier service 221 can include one or more classifiers (e.g., artificial neural network classification models). In some examples, each classifier can be used to compare the LLM prompt to a particular prompt template 104. For example, if there are five prompt templates 104, five classifiers can be trained for classification. Each classifiers can be trained for one of the prompt templates 104.

In block 320, the classifier service 221 can transmit a classification response to the agent service 230. In some examples, the classification response can include an indication that the LLM prompt matches a known prompt template 104. In other examples, the classification response can indicate which prompt template 104 is matched with the LLM prompt. In other examples, the classification response can indicate that the LLM prompt is unknown. The classification response can be added to the prompt data 236. The classification response can be used to accumulate metrics, such as a count of requests for each prompt template 104, a count of requests for unidentified prompts 245, and other suitable metrics.

If the classification response is known, then the processing operations can end for the LLM prompt. If the classification response is unknown, then the operations can proceed to block 323. As such, block 323 is omitted when the classification response provides a known template indication.

In block 323, the agent service 230 can transmit a request to the LLM service 218 to determine whether the LLM prompt matches previously stored unidentified prompts 245. The LLM service 218 can make the determination based at least in part on a similarity threshold. In some examples, the LLM service 218 can identify common prompt components. Some non-limiting examples of common prompt component can include shared instructions, a shared prompt structure, a shared prompt feature, a shared pattern, a common theme, and other suitable common elements between the LLM prompt and previously stored unidentified prompts 245. In some examples, a separate template identifier LLM service is trained (e.g., fine-turned) for identifying whether two unidentified prompts 245 can be classified as match for a new prompt template 104 based at least in part on the similarity threshold. For example, the separate template identifier LLM service can use a machine learning model that has been generated based at least in part on a dataset for identifying common prompt components.

If a match is identified between the LLM prompt and a previous stored unidentified prompt 245 by the LLM service 218 or by a separate template identifier LLM service, then the LLM service 218 or the separate template identifier LLM service can transmit an indication of a match and/or a new prompt template 104 to the agent service 230. The agent service 230 can proceed to block 326a. Block 326a can represent a workflow of tasks that are executed when a match has been identified with a previously stored unidentified prompt 245, in which the workflow starts at block 327.

Alternatively, if a match is not identified between the LLM prompt and a previous stored unidentified prompt 245, the LLM service 218 can transmit to the agent service 230 an indication that the LLM prompt will be stored an unidentified prompt 245 and/or does not match with the previous stored unidentified prompt 245. The agent service 230 can proceed to block 326b.

In block 327, the agent service 230 can generate the new prompt template 104 based at least in part on the common prompt components. Some non-limiting examples of common prompt components include shared instructions, a shared prompt structure, a shared prompt feature, a shared pattern, a common theme, and other suitable similar elements. In some examples, the LLM service 218 can generate the new prompt template 104 based at least in part on the common prompt components and provide the new prompt template 104 to the agent service 230.

In some examples, the agent service 230 can store the new prompt template 104 as an unidentified prompt 245 until an administrative user has an opportunity to review and approve the new prompt template 104 (via the administrative device 209). In this scenario, the new prompt template 104 can be stored as a prompt template 104 based at least in part on an approval by an administrative user received from the administrative user interface 115. After the execution of block 326, the agent service 230 can proceed to block 329.

Alternatively, in block 326b, the agent service 230 can transmit a request to the prompt injection detector 224 to evaluate whether the unidentified prompt 245 is associated with malicious activity. The prompt injection detector 224 can execute one or more approaches for identifying malicious activity aimed at compromising the LLM service 218. The prompt injection detector 224 can reply with a detector classification for indicating whether the unidentified prompt 245 is associated with a prompt injection attack.

In block 329, the agent service 230 can transmit a request to the LLM service 218 for training data 239 for the new prompt template 104. The request can represent a training LLM prompt that is generated by the agent service 230. In some examples, the training LLM prompt can be generated based at least in part on a training prompt template 104 for generating training data 239 (e.g., samples), in which the new prompt template 104 can be inserted for a placeholder of the training prompt template 104.

In block 333, the LLM service 218 can generate the training data 239 based at least in part on receiving the training LLM prompt. The LLM service 218 can be trained (e.g., fine-turned) for generating training data 239. In some examples, a separate sample generator LLM service is trained (e.g., fine-turned) for generating training data 239 for the new prompt template 104. After the generation of the data, the LLM service 218 can transmit the training data 239 to the agent service 230.

In block 336, the agent service 230 can transmit a request to the classifier service 221 to train a classifier for the new prompt template 104. The request can include the new prompt template 104 and the generated training data 239 for the new prompt template 104. The classifier service 221 can include one or more machine learning classification algorithms for generating a new classifier for the new prompt template 104 based at least in part on the generated training data 239 and the new prompt template 104. Some non-limiting examples of machine learning classification algorithms can include a Logistic Regression, Naïve Bayes, K-Nearest Neighbors, a Decision Tree, a Support Vector Machine, and other machine learning classification algorithms.

In block 339, the prompt injection detector 224 can transmit a detector classification to the agent service 230 based at least in part on receiving a request from the agent service 230 to analyze the unidentified prompt 245. The detector classification can be a classification on whether the unidentified prompt 245 is associated with malicious activity. The prompt injection detector 224 can include a machine learning model classifier that has been fined tuned for classifying malicious prompts. The prompt injection detector 224 can classify the unidentified prompt 245 as malicious prompts based at least in part on malicious documents associated with a retrieval augment generation, prompts with instructions to access malicious websites, prompts with an instruction that violates a security policy for a business, and other suitable prompt injection scenarios. In some examples, the machine learning model classifier can be trained on a data set that includes prompt injections of malicious activity and legitimate prompt requests.

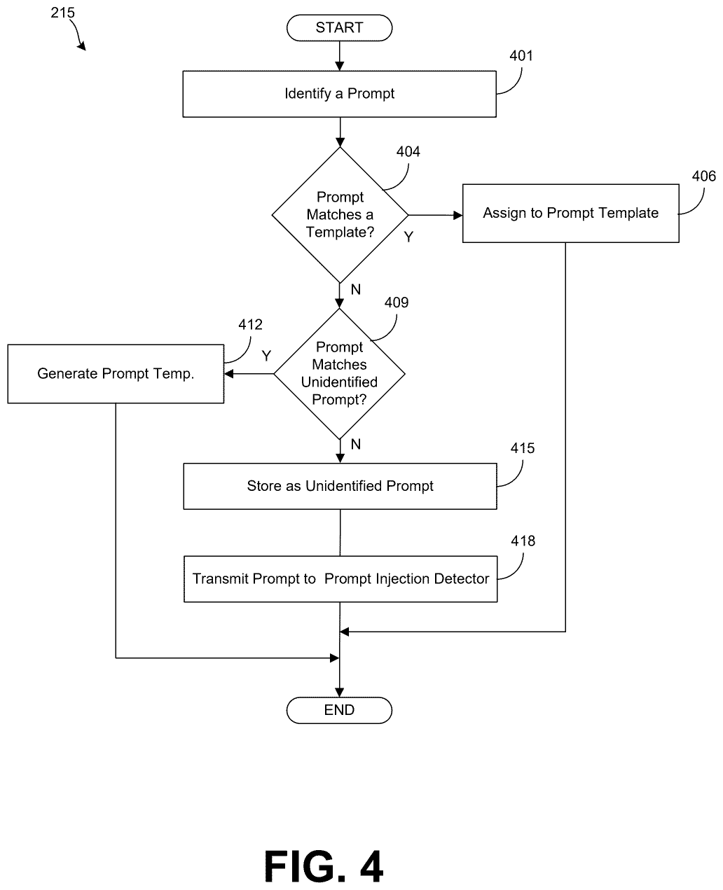

Referring next to FIG. 4, shown is a flowchart that provides one example of the operation of a portion of the management service 215. The flowchart of FIG. 4 provides merely an example of the many different types of functional arrangements that can be employed to implement the operation of the depicted portion of the management service 215. As an alternative, the flowchart of FIG. 4 can be viewed as depicting an example of elements of a method implemented within the network environment 200.

Beginning with block 401, the management service 215 can identify an LLM prompt that has been submitted by a client application 254, in which the LLM prompt is intended for the LLM service 218. In some example, the management service 215 can monitor application payloads and can identify the LLM prompt from an application payload.

In block 404, the management service 215 can determine whether the LLM prompt matches an existing prompt template 104. The management service 215 can transmit the LLM prompt to the classifier service 221 for a classification response. The classification response can indicate whether the LLM prompt is similar to one or more of the prompt templates 104. In some examples, the classification response can include an indication that the LLM prompt is associated with a known prompt template, an indication of the particular existing prompt template 104 that is matched with the LLM prompt, or other suitable classification responses. In some examples, the classifier service 221, via a trained neutral network model, can determine the classification response can be based at least in part on an identification of common prompt components, such as shared instructions, a shared prompt structure, a shared prompt feature, a shared pattern, a common theme, and other suitable similar elements.

If the LLM prompt matches an existing prompt template 104, then the management service 215 can proceed to block 406. If the LLM prompt does not match an existing prompt template 104, then the management service 215 can proceed to block 409.

In block 406, the management service 215 can assign the LLM prompt to the prompt template 104 associated with the match from block 404. The management service 215 can generate prompt data 236 associated with the classification response and/or assignment to the prompt template 104. The generation of the prompt data 236 can include updating a count of the requests for the prompt template 104, prompt template valuation data, and other suitable metrics associated with the prompt data 236.

In some examples, the management service 215 and/or the LLM service 218 can determine whether to update the prompt template 104 based at least in part the prompt data 236. For example, the LLM service 218 can identify additional common prompt components to add to the prompt template 104 or prompt components to remove from the prompt template 104 based at least in part on the prompt data 236. The updates can be determined based at least in part on the previously assigned prompts to the prompt template 104. In some examples, the LLM service 218 reply with an updated prompt template 104 that has been altered based at least in part on the prompt data 236 and other suitable feedback data. Then, the management service 215 can proceed to the end.

In block 409, the management service 215 can determine whether the LLM prompt matches an unidentified prompt 245, which was previously stored in the data store 233. The management service 215 can transmit a request to the LLM service 218 to determine whether the LLM prompt matches an unidentified prompt 245. The LLM service 218 can identify a match based at least at in part on a similarity threshold. The similarity threshold can be based at least in part on identifying common prompt components, such as shared instructions, a shared prompt structure, a shared prompt feature, a shared pattern, a common theme, and other suitable similar elements. The LLM service 218 can reply to the management service 215 with an indication of whether there is a match.

If the LLM prompt matches an unidentified prompt 245, then the management service 215 can proceed to block 412. If the LLM prompt does not match an unidentified prompt 245, then the management service 215 can proceed to block 415.

In block 412, the management service 215 can generate a prompt template 104 based at least in part on the match of the LLM prompt and the unidentified prompt 245. In some examples, the LLM service 218 can provide the new prompt template 104 when there is a match. The LLM service 218 can generate the new prompt template 104 based at least in part on the common prompt components. The LLM service 218 can provide the new prompt template 104 to the management service 215.

In block 415, the management service 215 can store the unidentified prompt 245 in the data store 233 when there is not a match between the LLM prompt and the unidentified prompt 245. The management service 215 can generate metrics associated with the unidentified prompt 245 for storage in the data store 233.

In block 418, the management service 215 can transmit a request to prompt injection detector 224 to determine whether the unidentified prompt 245 is associated with malicious activity. The prompt injection detector 224 can transmit to the management service 215 an indication of whether there is malicious activity. In some examples, if malicious activity is detected, the unidentified prompt 245 can be used for retraining a machine learning classifier model for the prompt injection detector 224. Then, the management service 215 can proceed to the end.

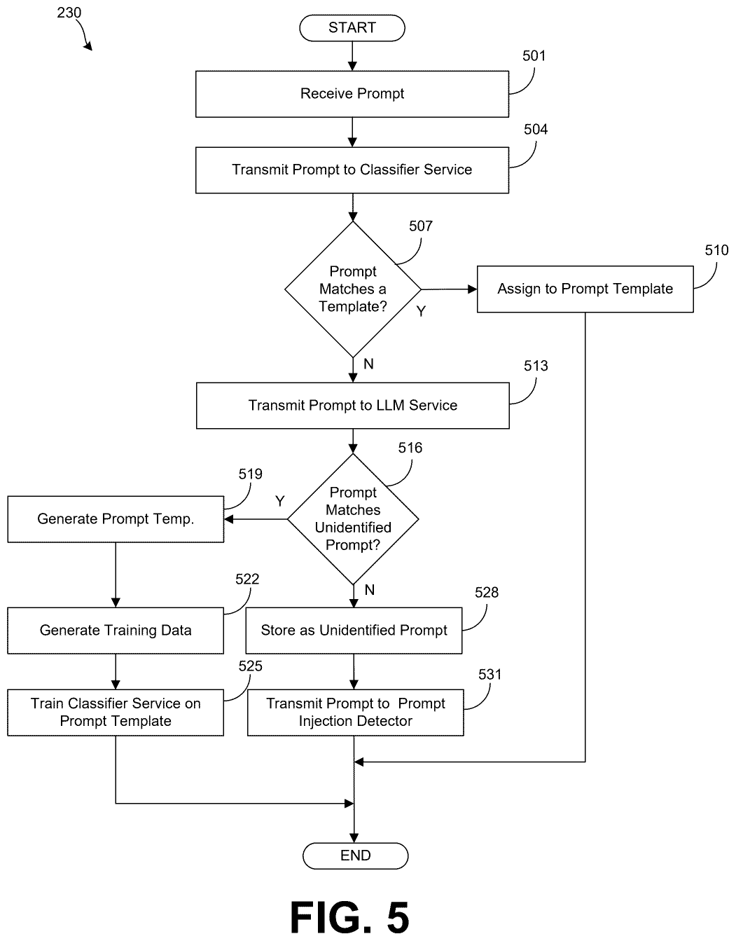

Referring next to FIG. 5, shown is a flowchart that provides one example of the operation of a portion of the agent service 230. The flowchart of FIG. 5 provides merely an example of the many different types of functional arrangements that can be employed to implement the operation of the depicted portion of the agent service 230. As an alternative, the flowchart of FIG. 5 can be viewed as depicting an example of elements of a method implemented within the network environment 200.

In block 501, the agent service 230 can receive a LLM prompt from the AI proxy 227. The AI proxy 227 can monitor application payloads from the client application 254 and can identify the LLM prompt from one of the application payloads. Then, the AI proxy 227 can transmit the LLM prompt to the agent service 230. The agent service 230 can be executed to coordinate an autonomous execution of a workflow.

In block 504, the agent service 230 can transmit the LLM prompt to the classifier service 221 for a classification response. The classification response can indicate whether the LLM prompt is similar to one or more of the prompt templates 104. In some examples, the classification response can include an indication that the LLM prompt is associated with a known prompt template, an indication of the particular existing prompt template 104 that is matched with the LLM prompt, or other suitable classification responses. In some examples, the classifier service 221, via a trained neutral network model, can determine the classification response can be based at least in part on an identification of common prompt components, such as shared instructions, a shared prompt structure, a shared prompt feature, a shared pattern, a common theme, and other suitable similar elements.

In block 507, the agent service 230 can determine whether the LLM prompt matches an existing prompt template 104 based at least part on the classification response received from the classifier service 221. The classifier service 221 can include one or more classifiers (e.g., artificial neural network classification models). In some examples, each classifier can be used to compare the LLM prompt to a particular prompt template 104. If the classification response indicates that the LLM prompt matches an existing prompt template 104, then the agent service 230 can proceed to block 510. If the classification response does not indicate a match with an existing prompt template 104, then the agent service 230 can proceed to block 513.

In block 510, the agent service 230 can assign the LLM prompt to the prompt template 104 associated with the match from block 507. The agent service 230 can generate prompt data 236 associated with the classification response and/or assignment to the prompt template 104. The generation of the prompt data 236 can include updating a count of the requests for the prompt template 104, prompt template valuation data, and other suitable metrics associated with the prompt data 236. Then, the agent service 230 can proceed to the end.

In block 513, the agent service 230 can transmit the LLM prompt to the LLM service 218 for determining whether LLM prompt matches an unidentified prompt 245 stored in the data store 233. The LLM service 218 can identify a match based at least at in part on a similarity threshold. The similarity threshold can be based at least in part on identifying common prompt components, such as shared instructions, a shared prompt structure, a shared prompt feature, a shared pattern, a common theme, and other suitable similar elements. The LLM service 218 can reply to the agent service 230 with a match response. In some example, a separate template identifier LLM service is used and specifically trained for identifying common prompt components.

In block 516, the agent service 230 can determine whether there is a match based at least in part on the match response received from the LLM service 218. If the match response indicates that the LLM prompt matches an unidentified prompt 245, then the agent service 230 can proceed to block 519. If the match response indicates that the LLM prompt does not match an unidentified prompt 245, then the agent service 230 can proceed to block 415.

In block 519, the agent service 230 can generate a prompt template 104 based at least in part on the match response. Further, the agent service 230 can generate the prompt template 104 based at least in part on the common prompt components identified between the LLM prompt and the unidentified prompt 245. The LLM service 218 can provide the new prompt template 104 to the agent service 230. In some example, a separate template identifier LLM service is used for generating the new prompt template 104.

In block 522, the agent service 230 can generate training data 239 for the new prompt template 104. In some examples, the agent service 230 can transmit a request for training data 239 to the LLM service 218. The request can be in the form of a LLM prompt that includes the new prompt template 104. The LLM prompt can provide an instruction for generating the training data 239 as additional sample prompts based at least in part on the new prompt template 104. In some example, a sample generator LLM service is used for generating the training data 239.

In block 525, the agent service 230 can train the classifier service 221 based at least in part on the training data 239. The agent service 230 can transmit a request to the classifier service 221 to train a classifier for the new prompt template 104. The request can include the new prompt template 104 and the generated training data 239 for the new prompt template 104. The classifier service 221 can include one or more machine learning classification algorithms for generating a new classifier for the new prompt template 104 based at least in part on the generated training data 239 and the new prompt template 104.

In block 528, the agent service 230 can store the unidentified prompt 245 in the data store 233 when there is not a match between the LLM prompt and the unidentified prompt 245. The agent service 230 can generate metrics associated with the unidentified prompt 245 for storage in the data store 233. The metrics can be used to identify an improper use of a prompt template 104, an effectiveness of the prompt template 104, or other suitable uses.

In block 531, the agent service 230 can transmit a request to prompt injection detector 224 to determine whether the unidentified prompt 245 is associated with malicious activity. The prompt injection detector 224 can transmit to the agent service 230 a detector classification that indicates whether there is malicious activity. In some examples, if malicious activity is detected, the unidentified prompt 245 can be used for retraining a machine learning classifier model for the prompt injection detector 224. Then, the agent service 230 can proceed to the end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The sequence diagram of FIG. 3 and the flowchart of FIG. 4 show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagram of FIG. 3 and the flowchart of FIG. 4 show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagram of FIG. 3 and the flowchart of FIG. 4 can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 203.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
identify a prompt that has been submitted by a client device for a large language model (LLM) service;
determine that the prompt fails to match an existing prompt template;
determine that the prompt and an unidentified prompt meet a similarity threshold based at least in part on a common prompt component shared between the prompt and the unidentified prompt; and
generate a prompt template for the LLM service based at least in part on the prompt and the unidentified prompt meeting the similarity threshold, the prompt template comprising the common prompt component and a placeholder.

2. The system of claim 1, wherein the determination that the prompt fails to match the existing prompt template further causes the computing device to at least:
transmit the prompt to a classifier service using a trained classifier neutral network model.

3. The system of claim 1, wherein the machine-readable instructions further cause the computing device to at least:
generate training data for the prompt template based at least in part on providing the prompt template to a sample generator LLM service.

4. The system of claim 1, wherein the machine-readable instructions further cause the computing device to at least:
generate a classifier neutral network model that is trained for identifying a respect prompt that is similar to the based at least in part on a training data generated for the prompt template.

5. The system of claim 4, wherein the machine-readable instructions further cause the computing device to at least:
add the classifier neutral network model to a classifier service used to classify a plurality of incoming prompts submitted by a plurality of client devices.

6. The system of claim 1, wherein the common prompt component is at least one of a shared instruction, a shared prompt structure, or a shared prompt feature.

7. The system of claim 1, wherein the prompt is identified based at least in part on receipt of the prompt from an artificial intelligence proxy that monitors a plurality of application layer payloads.

8. A method, comprising:
identifying, by a computing device, a prompt that has been submitted by a client device for a large language model (LLM) service;
determining, by the computing device, that the prompt fails to match an existing prompt template;
determining, by the computing device, that the prompt and an unidentified prompt meet a similarity threshold based at least in part on a common prompt component shared between the prompt and the unidentified prompt; and
generating, by the computing device, a prompt template for the LLM service based at least in part on the prompt and the unidentified prompt meeting the similarity threshold, the prompt template comprising the common prompt component and a placeholder.

9. The method of claim 8, wherein determining that the prompt fails to match the existing prompt template is based at least in part on transmitting the prompt to a classifier service using a trained classifier neutral network model.

10. The method of claim 8, further comprising:
generating, by the computing device, training data for the prompt template based at least in part on providing the prompt template to a sample generator LLM service.

11. The method of claim 8, further comprising:
generating, by the computing device, a classifier neutral network model that is trained for identifying a respect prompt that is similar to the based at least in part on a training data generated for the prompt template.

12. The method of claim 11, further comprising:
adding the classifier neutral network model to a classification service used to classify a plurality of incoming prompts submitted by a plurality of client devices.

13. The method of claim 8, wherein the common prompt component is at least one of a shared instruction, a shared prompt structure, or a shared prompt feature.

14. The method of claim 8, wherein the prompt is identified based at least in part on receiving the prompt from an artificial intelligence proxy that monitors a plurality of application layer payloads.

15. A non-transitory, computer-readable medium, comprising machine-readable instructions that, when executed by a processor of a computing device, cause the computing device to at least:
identify a prompt that has been submitted by a client device for a large language model (LLM) service;
determine that the prompt fails to match an existing prompt template;
determine that the prompt and an unidentified prompt meet a similarity threshold based at least in part on a common prompt component shared between the prompt and the unidentified prompt; and
generate a prompt template for the LLM service based at least in part on the prompt and the unidentified prompt meeting the similarity threshold, the prompt template comprising the common prompt component and a placeholder.

16. The non-transitory, computer-readable medium of claim 15, wherein the determination that the prompt fails to match the existing prompt template further causes the computing device to at least:
transmit the prompt to a classifier service using a trained classifier neutral network model.

17. The non-transitory, computer-readable medium of claim 15, wherein the machine-readable instructions, when executed by the processor, further cause the computing device to at least:
generate training data for the prompt template based at least in part on providing the prompt template to a sample generator LLM service.

18. The non-transitory, computer-readable medium of claim 15, wherein the machine-readable instructions, when executed by the processor, further cause the computing device to at least:
generate a classifier neutral network model that is trained for identifying a respect prompt that is similar to the based at least in part on a training data generated for the prompt template.

19. The non-transitory, computer-readable medium of claim 18, wherein the machine-readable instructions, when executed by the processor, further cause the computing device to at least:
add the classifier neutral network model to a classification service used to classify a plurality of incoming prompts submitted by a plurality of client devices.

20. The non-transitory, computer-readable medium of claim 15, wherein the common prompt component is at least one of a shared instruction, a shared prompt structure, or a shared prompt feature.
